(19) United States
(12) Patent Application Publication
(10) Pub. No.: US 2022/0008849 A1
(43) Pub. Date: Jan. 13, 2022

(54) PLATE FILTER FOR COFFEE MAKERS AND THE LIKE, AND COFFEE MAKER INCLUDING SAID FILTER

(71) Applicant: LUIGI LAVAZZA S.p.A., Torino (IT)

(72) Inventor: Marcello ARCANGELI, Torino (IT)

(21) Appl. No.: 17/312,188

(22) PCT Filed: Dec. 9, 2019
(86) PCT No.: PCT/IB2019/060556

§ 371 Date: Jun. 9, 2021

(30) Foreign Application Priority Data
Dec. 11, 2018 (IT) 202018000003914

(51) Int. Cl. B01D 39/12; A47J 31/06; A47J 31/30

(52) U.S. Cl. CPC B01D 39/12; B01D 2239/1216; A47J 31/303; A47J 31/0663

(57) ABSTRACT

A plate filter for coffee makers and the like, such as moka pots, Neapolitan flip coffee makers, coffee presses, or percolators, comprises a filtering wall (6a) provided with a plurality of holes or apertures (8) that define as a whole a substantially mesh-like structure having, according to the DIN 791 standard, a long side of mesh pitch or major diagonal (DL) that is less than 2 mm±5%, in particular comprised between 0.1 and 1.9 mm±5%, preferably comprised between 0.6 and 1 mm±5%, and even more preferably of 0.85 mm±5%.

### FIELD OF THE INVENTION

The present invention relates to the sector of coffee makers and the like and has been developed with particular reference to plate filters. The invention finds a preferred application in relation to coffee makers of a moka type, but not excluded is use thereof in Neapolitan flip coffee makers, coffee presses (French presses), or coffee percolator devices.

### PRIOR ART

Operation of coffee makers, as well as of similar devices for preparing of beverages starting from water and ground coffee, is usually based upon provision of filtering systems, aimed at preventing the final beverage from containing solid residue of the ground coffee. For this purpose, many coffee makers (or coffee maker) comprise two main bodies, namely, a boiler body, which is filled with the water to be heated, and a collector body for collecting the brewed coffee, these two bodies being operatively connected in fluid communication, with the filtering means set in between.

In the case of coffee makers of a moka type, the aforesaid filtering means typically comprise a filter funnel, having an upper part that is shaped for containing a dose of ground coffee and a lower part that is shaped for drawing the water from the boiler body and for enabling the pressurized water to rise from the boiler body towards the collector body. The latter has, within its cavity, a central column (chimney) having in general two lateral upper opening, from which the beverage obtained can come out thanks to passage of the pressurized water through the dose of coffee.

The filtering means of the coffee maker typically also comprise a plate filter (also known as “plate filter”), mounted on the collector body upstream of the aforesaid column and designed to face the dose of coffee contained in the upper part of the filter funnel. The plate filter has apertures or holes that are traversed by the pressurized water immediately after it has passed through the dose of ground coffee. The dimensions of the holes are chosen so as to prevent the ground coffee from being entrained by the water through the column, and hence from reaching the cavity of the collector body into which the beverage finally flows.

It has been found that the taste of the coffee beverage that reaches the cavity of the collector body of a coffee maker frequently has the tendency to worsen in the course of the preparation process.

Amongst the various solutions proposed in the past to mitigate this drawback, i.e., to increase the portion of beverage with a pleasant taste, there is that of obtaining the plate filter by cutting and shaping in an appropriate way a metal screen with given characteristics. In this connection, known from WO 2016/103289 A1 is, for example, a plate filter obtained in the way referred to, using metal screens made of aluminium or steel that with reference also to FIG. 9 for the nomenclature used meet the following specific requisites, determined according to the DIN 791 standard:
long way of mesh pitch or major diagonal (DL): from 2 mm to 10 mm, in particular from 3 mm to 7 mm, even more in particular from 4 mm to 6 mm;
short way of mesh pitch or minor diagonal (DC): from 0.1 mm to 5 mm, in particular from 0.5 mm to 3 mm, even more in particular from 0.6 mm to 1 mm, and more preferably still from 0.7 mm to 0.9 mm;
strand width (av): from 0.1 mm to 15 mm, in particular from 0.2 mm to 3 mm, even more in particular from 0.2 mm to 0.8 mm;
percentage of open area: from 15% to 90%, in particular from 50% to 80%, even more in particular from 60% to 70%.

### AIM AND SUMMARY OF THE INVENTION

In view of the above prior art, the aim of the present invention is basically to provide a newly devised plate filter that is able to improve further the quality of the coffee beverage that can be obtained with a coffee maker or similar preparation device.

The above aim is achieved, according to the present invention, by a plate filter for coffee makers and the like having the characteristics specified in claim 1. Further advantageous developments of the invention are specified in the dependent claims 2-14. The aim of the invention is moreover achieved by coffee makers and similar devices that include such a plate filter, according to claims 15 and 16. The claims form an integral part of the technical teaching provided herein in relation to the invention.

### BRIEF DESCRIPTION OF THE DRAWINGS

Further aims, characteristics, and advantages of the invention will emerge clearly from the ensuing detailed description, with reference to the annexed drawings, in which:

FIG. 1 is a schematic representation in partial cross-sectional view of a coffee maker of a moka type;

FIG. 2 is a schematic view in side elevation of a plate filter according to possible embodiments of the invention;

FIGS. 3 and 4 are schematic perspective views from different angles of a plate filter according to possible embodiments of the invention;

FIG. 5 is a schematic top plan view of a plate filter according to possible embodiments of the invention;

FIG. 6 is a schematic cross-sectional view of a plate filter according to possible embodiments of the invention;

FIG. 7 is a detail of FIG. 5 at a larger scale;

FIG. 8 is a schematic representation of a portion of a plate filter according to possible embodiments of the invention;

FIG. 9 is a schematic representation of a portion of a generic plate filter, with indication of corresponding characteristic parameters;

FIG. 10 is a representation in lateral section of a portion of a plate filter according to possible embodiments of the invention; and

FIG. 11 is a schematic representation aimed at exemplifying the profile of an aperture or hole of a plate filter according to possible embodiments of the invention.

### DESCRIPTION OF PREFERRED EMBODIMENTS OF THE INVENTION

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment”, “in one embodiment”, and the like, that may be present in different points of this description do not necessarily refer to one and the same embodiment. Moreover, particular conformations, structures, or characteristics may be combined in any adequate way in one or more embodiments. The references used herein are only provided for convenience and hence do not define the sphere of protection or the scope of the embodiments.

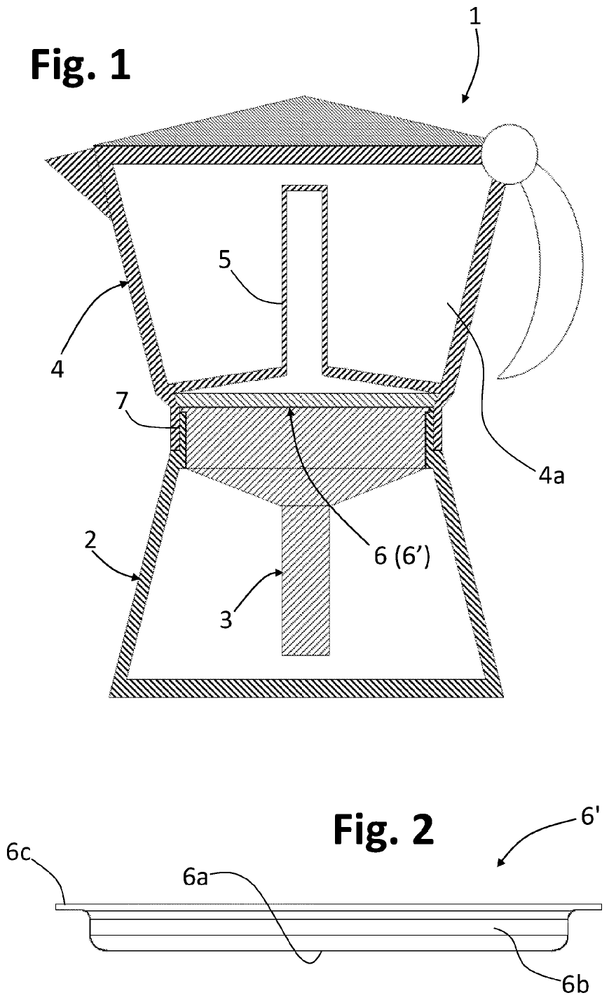

FIG. 1 shows in an extremely schematic way a coffee maker, designated as a whole by 1. In the example represented, the coffee maker 1 is of a moka type and comprises a boiler body 2 having an upper mouth, for receiving the water to be heated necessary for preparation of a coffee beverage. The boiler body 2 is laterally provided with a usual safety (or pressure-relief) valve, not shown.

The upper mouth of the boiler body 2 is shaped so as to define a seat for positioning a filter funnel 3, which is configured for containing a dose of ground coffee, in bulk form or in a compacted form (cake), or else contained in a porous pod, for example made of filter paper. The coffee maker 1 further comprises an upper collector body 4, which is configured for being coupled in fluid communication with the boiler 2 and defines a cavity 4a for collection of the beverage, extending at the centre of which is a delivery chimney or column 5.

The base part of the collector body 4 defines a housing, mounted in which is a plate filter 6, with possible peripheral seal means, such as an annular gasket, not represented. According to a technique in itself known, the plate filter 6 is mounted in a fixed position, but, if need be, can be removed from its housing, for example for replacement thereof.

As also already mentioned in the introductory part of the present description, typical use of the coffee maker 1 envisages loading into the boiler body 2 the water necessary for preparation of the coffee beverage. Next, the filter funnel 3 is set in the corresponding seat defined at the mouth of the boiler body 2, and the upper part of the funnel 3 is filled with the dose of ground coffee. The upper collector body 4 can then be secured to the boiler body 1, in particular via a threaded coupling 7, with the plate filter 6 facing the dose of coffee. Subsequent heating of the boiler body 2 will cause passage of the hot pressurized water through the filter funnel 3, through the dose of coffee contained therein, and through the plate filter 6: the coffee beverage thus obtained climbs up the column 5 and then comes out into the cavity 4A of the collector body 4.

The delivery process may be considered as being divided into two phases. In the first phase, also known as “regular extraction”, there is start of delivery, i.e., of passage of water from the boiler body 2 to the collector body 4, at a very low pressure (approximately, 0.1 to 0.2 bar) and at a temperature of around 55/60° C. In this phase, the ground coffee of the dose contained in the filter funnel 3 tends to rise entrained by the water towards the column 5 of the collector body 4, thus distributing in part on the plate filter 6.

In the second phase of the process, also known as “forced extraction”, the water continues to pass through the ground coffee present in the filter funnel 3, but may encounter a little more resistance due to the presence of the ground coffee on the plate filter 6 following upon the first phase. This resistance is higher if in the filter funnel 3 an excessive dose of coffee has been introduced such as to cause compression thereof between the filter funnel 3 and the plate filter 6. The pressure of the water can hence rise decidedly as compared to the first phase (up to 0.8 to 1.5 bar according to the amount and grain size of the coffee), with a consequent rise in temperature of the extracted product, which may even reach values of between 85° C. and 100° C.: this causes a very intense evaporation, which may lead to a sharp, bitter, or sour taste of the coffee beverage.

The invention is based upon the consideration of the fact that, to obtain a correct extraction with a coffee maker, in particular a moka pot, it would be necessary to respect the air-to-water ratios of the boiler body, normally defined in the instructions accompanying the coffee maker, and not to press the coffee down inside the filter funnel. In practice, however, these instructions are rarely followed by the end consumer since in the majority of cases the water is introduced into the boiler body in excess (typically above the level of the corresponding safety valve) and/or the ground coffee is introduced in an excessive amount in the filter funnel (the classic “heap” of coffee, which is then compressed when the boiler body and the collector body are coupled together).

To enable a delivery at optimal temperatures, i.e., not beyond 80° C., preferably comprised between 75° C. and 78° C., the invention proposes to intervene on the filtering system of the coffee maker and, more precisely, on the plate filter mounted on the collector body, without having to intervene radically on the extraction system, at the same time preventing passage of fine particles of ground coffee.

According to the invention, the sections of passage of the fluid through the plate filter have been modified in order to obtain reduction of the pressures and temperatures of the extracted product, and further withhold the fine coffee particles.

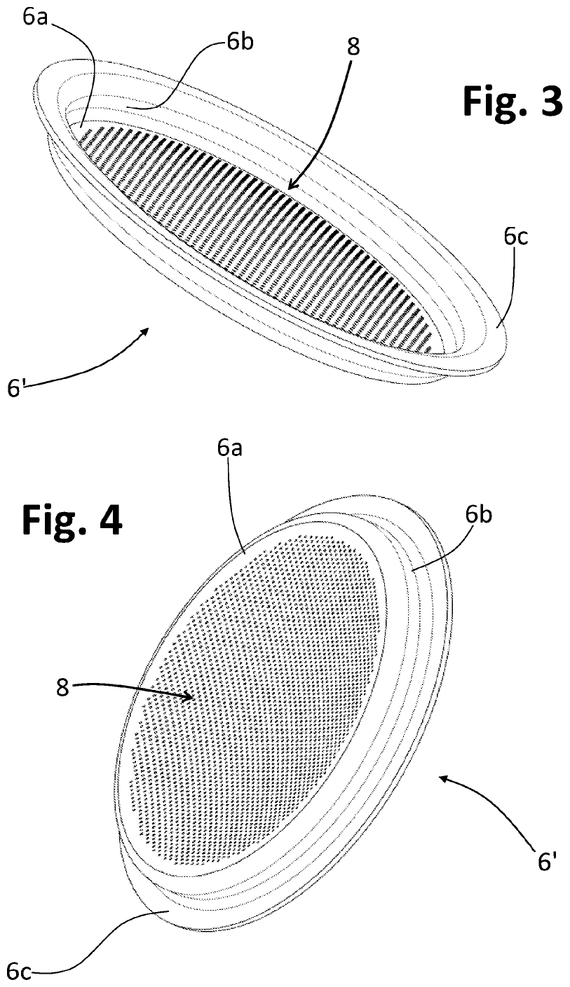

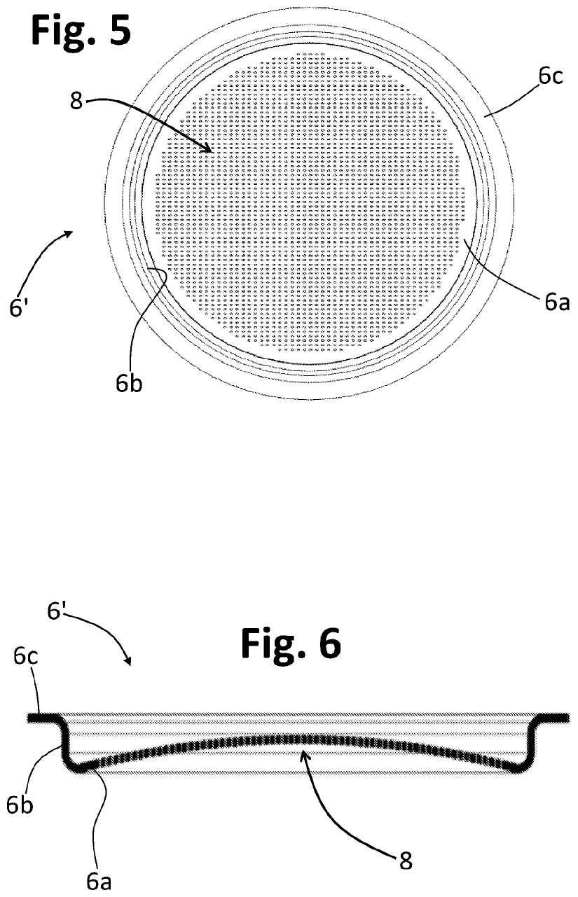

FIGS. 2-5 represent schematically a plate filter provided according to possible embodiments of the invention. In the example, the plate filter designated as a whole by 6′ has a bottom or filtering wall 6a, preferably substantially circular, which is provided with an array of holes or apertures 8. The holes 8 define as a whole an empty or open area that is a fraction of the total area of the wall 6a that is to face the filter funnel, i.e., the dose of ground coffee. In the case exemplified, the body of the plate filter 6′ is shaped so as to define also a peripheral wall 6b. In the example, the peripheral wall 6b has, at its end opposite to the filtering wall 6a, a flange 6c radially projecting outwards. The flange 6c is advantageously used for fixing the plate filter 6′, in position together with an annular gasket, not represented.

As visible in particular in FIG. 6, the filtering wall 6a is preferably dome-shaped, with the concavity of the dome shape that in the assembled condition of the coffee maker is directed towards the corresponding boiler body, or the filter funnel. The choice of this conformation does not in any case have an imperative nature, in so far as the plate filter 6′ could have, for example, a filtering wall 6a with a concavity opposite to the one represented, or else a plane or substantially plane filtering wall 6a.

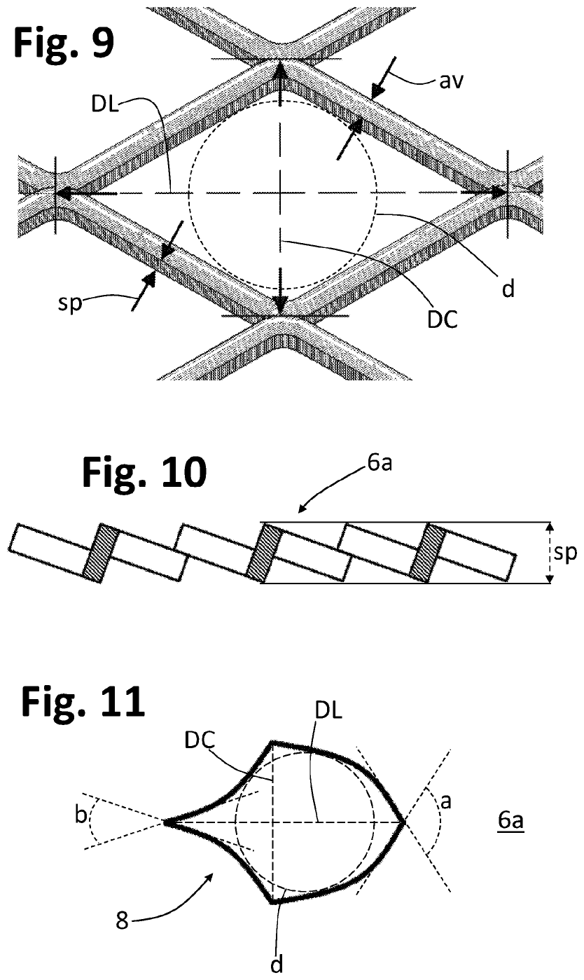

According to the invention and with reference once again to FIG. 9 for the nomenclature used the mesh structure of the plate filter 6′, i.e., of the filtering wall 6a, has a long way of mesh pitch or major diagonal (DL) of less than 2 mm, in particular comprised between 0.1 and 1.9 mm, more in particular comprised between 0.6 and 1 mm (±5%).

Preferably, moreover, the empty or open area of the filtering wall 6a is not less than 25% (±5%) of the total area of the wall or of its part that is to face the dose of coffee, or the corresponding containment space defined by the filter funnel. The empty or open area of the wall 6a may in any case be more than 25%.

The short way of mesh pitch or minor diagonal (DC) is preferably not greater than 1 mm, in particular comprised between 0.4 and 0.8 mm (±5%). The holes 8 overall define as a substantially mesh-like structure having a strand width (av) that is preferably not greater than 0.3 mm, in particular comprised between 0.20 and 0.25 mm (±5%). The filtering wall 6a of the plate filter 6′ has a thickness preferably not greater than 0.3 mm, in particular comprised between 0.15 and 0.25 mm (±5%).

The preferred material used for production of the plate filter according to the invention is stainless steel, for example of the AISI 304L type, though not excluded is the use of other materials, such as aluminium.

FIG. 8 illustrates in a schematic way a portion of the perforated filtering wall 6a of a plate filter according to the invention, visible in which is a possible geometry of the holes or apertures 8. As may be noted, in various embodiments, the holes 8 have at least one side generally curved or rounded.

According to possible advantageous embodiments, the curvatures of one or more sides of the holes 8 may vary, in particular as a function of the distance of the hole considered from the centre of the filtering wall 6a. This characteristic may prove particularly useful in the case of coffee makers of a moka type in order to direct the flow of water towards the inlet of the column 5 of the collector body 4 with a relatively swirling motion.

Irrespective of the specific shape of the holes or apertures 8, their profile is preferably such that it is possible to inscribe a circle therein with a diameter not greater than 0.3 mm, in particular comprised between 0.15 and 0.25 mm (±5%).

It is moreover particularly advantageous for the holes 8 of the filtering wall 6a to be obtained via laser cutting. This characteristic simplifies production of the filtering wall 6a starting from plane sheet metal, in view of the small dimensions of the holes 8 and/or their geometry.

Not, on the other hand, excluded is the possibility of obtaining the filtering wall 6a, for example, via calendering or stretching of plane sheet metal, so as to obtain, on a side of each hole or aperture 8, a fin inclined with respect to the aperture itself, as exemplified in FIG. 10, preferably with an inclination comprised between 0° and 55°, preferably comprised between 1° and 30°, and even more preferably comprised between 2° and 10°.

Practical tests conducted by the present Applicant have shown how the plate filter according to the invention enables the aims set forth to be achieved.

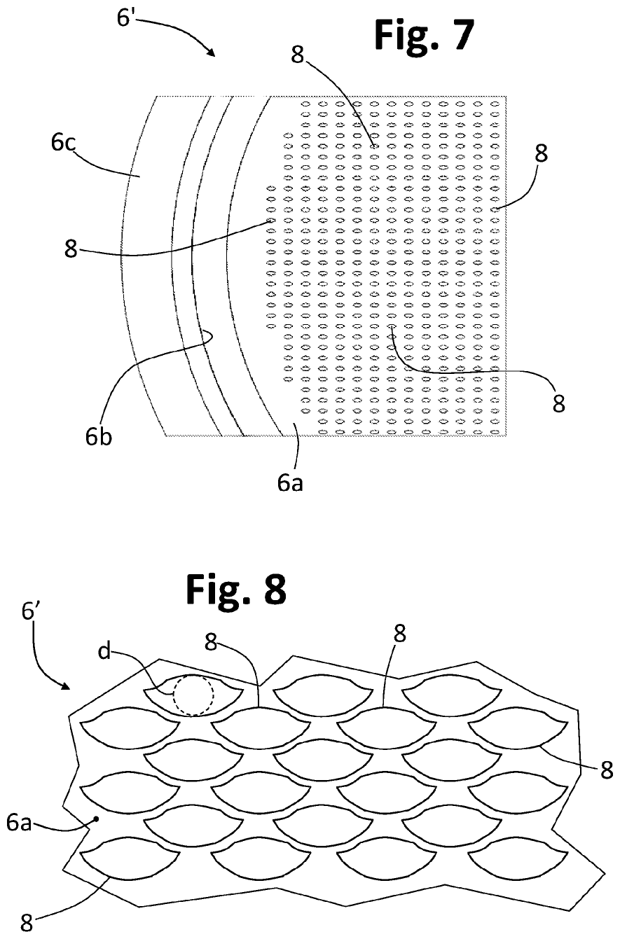

For this purpose, a plate filter 6′ having a geometry of the type represented in FIGS. 2-7 was obtained starting from a plate of AISI 304L stainless steel, with a starting thickness approximately 0.15 mm±5%. The plate was machined in order to form the corresponding array of holes 8, with a mesh structure having the following characteristics, according to the DIN 791 standard and once again with reference to FIG. 9 for the corresponding nomenclature:
major diagonal (DL): 0.85 mm±5%
minor diagonal (DC): 0.65 mm±5%
strand width (av): 0.23 mm±5%
final thickness (sp) 0.20 mm±5%
percentage of empty area 25%±5%
inscribed diameter (d) 0.20 mm±5%
weight of machined plate 0.700 kg/m²±10% approx.

The tests were conducted using two different moka pots, i.e., a coffee maker model “Carmencita” manufactured by the present Applicant in the standard configuration (Coffee maker 1) and a coffee maker model “Carmencita” manufactured by the present Applicant in a modified configuration, i.e., provided with a plate filter according to the invention (Coffee maker 2).

The pressures were measured with a glycerin manometer applied to the boiler body of the coffee makers. The temperatures of the beverage delivered were detected with a thermocouple located at the slits of the column of the coffee maker. The water introduced at the beginning into the boiler body was at a temperature of 18° C.

As heat source a gas burner with a diameter of 70 mm was used at a constant power of 1.15 NL/S. To compare the various parameters with the two moka pots, four different commercially available coffee blends of different producers were used (BLEND 1, BLEND 2, BLEND 3, BLEND 4).

The results of the tests with the two coffee makers are highlighted in the tables below.

TABLE 1
Tests conducted with standard Lavazza coffee maker

| COFFEE MAKER 1 | BLEND 1 | | | BLEND 2 | | | BLEND 3 | | | BLEND 4 | | |
|---|---|---|---|---|---|---|---|---|---|---|---|---|
| Test No. | 1 | 2 | 3 | 4 | 5 | 6 | 7 | 8 | 9 | 10 | 11 | 12 |
| Q water (cc) | 15 | 15 | 15 | 15 | 15 | 15 | 15 | 15 | 15 | 15 | 15 | 15 |
| Q ground coffee (g) | 126 | 126 | 128 | 124 | 125 | 126 | 125 | 130 | 128 | 126 | 125 | 128 |
| Temperature (° C.) | 88 | 90 | 90 | 92 | 90 | 89 | 93 | 92 | 90 | 89 | 91 | 89 |
| Pressure (bar) | 0.8 | 0.9 | 1 | 0.9 | 0.8 | 0.8 | 1.3 | 1.5 | 1.2 | 0.9 | 0.8 | 0.8 |

TABLE 2
Tests conducted with Lavazza coffee maker according to the invention

| COFFEE MAKER 2 | BLEND 1 | | | BLEND 2 | | | BLEND 3 | | | BLEND 4 | | |
|---|---|---|---|---|---|---|---|---|---|---|---|---|
| Test No. | 1 | 2 | 3 | 4 | 5 | 6 | 7 | 8 | 9 | 10 | 11 | 12 |
| Q water (cc) | 15 | 15 | 15 | 15 | 15 | 15 | 15 | 15 | 15 | 15 | 15 | 15 |
| Q ground coffee (g) | 128 | 124 | 128 | 127 | 125 | 128 | 125 | 126 | 124 | 130 | 127 | 125 |
| Temperature (° C.) | 75 | 77 | 77 | 74 | 76 | 75 | 78 | 80 | 80 | 76 | 75 | 75 |
| Pressure (bar) | 0.6 | 0.7 | 0.7 | 0.5 | 0.7 | 0.7 | 0.9 | 1 | 1 | 0.7 | 0.7 | 0.6 |

From the comparison between the results of the two tables it clearly emerges how, irrespective of the type of blend used, the temperatures and pressures of the extract obtained with the coffee maker provided with the plate filter according to the invention are decidedly lower than the corresponding values obtained with the standard coffee maker.

The mean values of temperature and pressure appear in the table below.

TABLE 3
Mean values of temperature and pressure

| Coffee maker | Mean temperature | Mean pressure |
|---|---|---|
| COFFEE MAKER 1 | 90.2 | 0.88 |
| COFFEE MAKER 2 | 76.5 | 0.73 |

It is again pointed out how the coffee beverages obtained with the two machines were both substantially immune of residue of ground coffee.

From the description provided the characteristics of the present invention consequently emerge clearly, as likewise do its advantages. In particular, the sections of passage proposed for the plate filter according to the invention make it possible to obtain a significant reduction of the pressures and temperatures of the extracted coffee beverage, at the same time guaranteeing that the fine coffee particles will be withheld.

It is clear that numerous variations may be made by the person skilled in the art to the delivery device described by way of example, without thereby departing from the scope of the invention as defined in the ensuing claims.

FIG. 11 illustrates by way of example a possible geometry of holes or apertures that can be used in a plate filter according to the invention, different from the one exemplified in FIG. 8. In this case, the hole 8 represented has four generally curved sides, arranged in pairs according to an axis of symmetry, here substantially corresponding to the long way or major diagonal DL, and with equal sides specular with respect to the aforesaid axis or diagonal that form, at one end of the hole 8, an internal angle “a” greater than 90° and, at the opposite end, an internal angle “b” smaller than 90°, the other two angles that identify the short way or minor diagonal DC being substantially the same as one another. As already mentioned, curved or rounded sides of the type exemplified have the effect of inducing a sort of rotation of the flow at outlet from the plate filter, and a consequent relatively swirling motion. Holes 8 having the geometry exemplified in FIG. 11 may, for example, be defined on the filtering wall 6a according to concentric circumferences with progressively decreasing radius, in particular with the minor diagonal (DC) substantially facing the centre of the aforesaid wall.

1. A plate filter for coffee makers and the like, comprising a filtering wall provided with a plurality of apertures or holes that define as a whole a substantially mesh-like structure having, according to the DIN 791 standard, a long way of mesh pitch or major diagonal that is less than 2 mm±5%.

2. The plate filter according to claim 1, wherein the substantially mesh-like structure has, according to the DIN 791 standard, a short way of mesh pitch or minor diagonal that is not greater than 1 mm±5%.

3. The plate filter according to claim 1, wherein the holes of the plurality each have a profile such that a circle can be inscribed therein with a diameter not greater than 0.3 mm±5%.

4. The plate filter according to claim 1, wherein the plurality of holes defines an empty or open area of the filtering wall that is not less than 25%±5% of the total area of said wall or at least of a part thereof designed to face a dose of ground coffee.

5. The plate filter according to claim 1, wherein the substantially mesh-like structure has, according to the DIN 791 standard, a strand width not greater than 0.3 mm±5%.

6. The plate filter according to claim 1, wherein the filtering wall has a thickness not greater than 0.3 mm±5%.

7. The plate filter according to claim 1, wherein the plate filter is made of stainless steel.

8. The plate filter according to claim 1, wherein the holes of the plurality have at least one side generally curved or rounded.

9. The plate filter according to claim 8, wherein a curvature of at least one side of the holes of the plurality varies as a function of a distance of the holes from the centre of the filtering wall.

10. The plate filter according to claim 1, wherein the holes of the plurality have four generally curved sides, arranged in pairs according to an axis of symmetry identified by a respective long way of mesh pitch or major diagonal, with equal sides specular with respect to said axis that form, at one end of the respective hole, an internal angle greater than 90° and, at the opposite end, an internal angle smaller than 90°, the other two internal angles that identify a short way of mesh pitch or minor diagonal being substantially the same as one another.

11. The plate filter according to claim 1, wherein the filtering wall is a dome-shaped wall.

12. The plate filter according to claim 1, further comprising a peripheral wall that is provided, at one end thereof opposite to the filtering wall, with a flange radially projecting outwards.

13. The plate filter according to claim 1, wherein the filtering wall has, at one side of each hole, an inclined fin.

14. The plate filter according to claim 1, wherein the holes of the plurality are laser-cut holes.

15. A coffee maker or the like, selected from among a moka coffee maker, or a Neapolitan flip coffee maker, or a coffee press, or a percolator, comprising a plate filter according to claim 1.

16. A coffee maker of a moka type, comprising a boiler body and a collector body coupleable in a fluid-tight way to one another, with filtering means set in between that comprise a filter funnel and a plate filter according to claim 1.

17. The plate filter according claim 13, wherein the inclined fin has an inclination comprised between 0° and 55°, or between 1° and 30°, or between 2° and 10°.

18. A plate filter for coffee makers and the like, comprising a filtering wall provided with a plurality of apertures or holes that define as a whole a substantially mesh-like structure having, according to the DIN 791 standard:
a long way of mesh pitch or major diagonal that is less than 2 mm±5%,
a short way of mesh pitch or minor diagonal that is not greater than 1 mm±5%,
a strand width not greater than 0.3 mm±5%,
wherein the plurality of holes defines an empty or open area of the filtering wall that is not less than 25%±5% of the total area of said wall or at least of a part thereof designed to face a dose of ground coffee,
wherein the holes of the plurality each have a profile such that a circle can be inscribed therein with a diameter not greater than 0.3 mm±5%,
and wherein the filtering wall has a thickness not greater than 0.3 mm±5%.

19. The plate filter according to claim 18, wherein the substantially mesh-like structure has, according to the DIN 791 standard, at least one from among:
a long way of mesh pitch or major diagonal comprised between 0.1 and 1.9 mm±5%, or comprised between 0.6 and 1 mm±5%,
a short way of mesh pitch or minor diagonal comprised between 0.4 and 0.8 mm±5%,
a strand width comprised between 0.20 and 0.25 mm±5%,
a thickness comprised between 0.15 and 0.25 mm±5%,
a diameter of the circle that can be inscribed in the profile of each hole of the plurality comprised between 0.15 mm and 0.25 mm±5%.

20. The plate filter according to claim 19, wherein:
said long way of mesh pitch or major diagonal is 0.85 mm±5%,
said short way of mesh pitch or minor diagonal is 0.65 mm±5%,
said strand width is 0.23 mm±5%,
said thickness is 0.20 mm±5%,
said diameter is 0.20 mm±5%.
